(19) United States
(12) Patent Application Publication
(10) Pub. No.: US 2016/0347250 A1
(43) Pub. Date: Dec. 1, 2016

(54) Vehicle System For Providing Indirect View Around A Commercial Vehicle

(71) Applicants: Andreas Enz, Columbia, SC (US); Simon Deffner, Flachslanden (DE); Werner Lang, Ergersheim (DE)

(72) Inventors: Andreas Enz, Columbia, SC (US); Simon Deffner, Flachslanden (DE); Werner Lang, Ergersheim (DE)

(21) Appl. No.: 14/725,648

(22) Filed: May 29, 2015

(51) Int. Cl. B60R 1/00; H04N 7/18

(52) U.S. Cl. CPC B60R 1/00; H04N 7/181; B60R 2300/105; B60R 2300/102

(57) ABSTRACT

A vehicle system for providing indirect view around a commercial vehicle. The system has a first image capture unit oriented such that an angle of view of the first image capture unit is directed in a first directional component opposite the main driving direction of the vehicle. A second image capture unit is provided having at least one sensor device oriented such that the angle of view of the second image capture unit is directed in a second directional component in the main driving direction of the vehicle. A calculating unit receives image data from at least the second image capture unit and provides information extracted from the received image data to at least one of a vehicle assistance device, an autonomous vehicle guidance device and a display device within the driver's view.

### BACKGROUND OF THE INVENTION

1. Field of the Invention

The present invention relates to a system which allows to visually depict regions around a commercial vehicle in or next to a driver's cab of the commercial vehicle, such that these regions are visible or viewable for a driver when seated in the driver's seat by indirect view and/or to provide information about these regions to a vehicle assist system or autonomous vehicle guidance system.

2. Description of the Related Art

In particular in commercial vehicles having a pronounced hood, like for example long-hood trucks or short-hood trucks as they are used in North America, the indirect view of the driver is remarkably restricted, especially in the region aligned with the front axle in the longitudinal direction of the vehicle to the front end of the vehicle (bumper), or an indirect view is not possible at all. For this reason, so called fender mirrors, which are mirrors placed on the hood, are used. However, these fender mirrors are directed backwards, such that the regions adjacent to the vehicle which can be seen by means of these fender mirrors by the driver are regions extending backwards of the fender mirrors.

These regions next to the vehicle, which are hardly visible by means of mirrors or corresponding known indirect means of view are usually also not accessible by direct view. Even though the direct view is not hindered in modern long-hood trucks or short-hood trucks, due to the shape and geometry of the hoods of the trucks the direct view is usually nowadays clearly improved. However, the regions immediately adjacent to the hood cannot be directly seen by the driver, since the view is limited by the window openings of the driver's cabin and the hood itself.

In non-hood trucks, as they are used in Europe, the driver's cabin is usually provided with a front mirror, which is directed downwards and shows the region immediately adjacent to the driver's cabin. However, the use of such front mirrors is not possible or of minor help, because the hood is exactly in that region which is usually indirectly visible or viewable by a driver sitting in the driver seat and looking in the front mirror.

U.S. Pat. No. 8,953,011 refers to a system for indirect vision of a commercial vehicle, comprising a display unit disposed within a driver's cab of the commercial vehicle, wherein the display device is adapted to permanently and in real time display at least two fields of view which are to be permanently displayed during operation of the vehicle, on the display unit in a common image, wherein the at least two fields of view contain a field of view corresponding to a primary mirror and a field of view corresponding to a wide angle mirror of the same side of the vehicle. Both fields of view are displayed in a common image. This system, however, does not solve the problem of long-hood or short-hood North American type trucks, regarding the limited view in regions next to the vehicle hood and the driver's cabin. Further, in North American trucks, only the use of main mirrors is required by law, i.e. legally prescribed, such that, when relying on mirrors alone, the view to the rear might be even more limited than in conventional commercial vehicles in Europe, wherein a main mirror and a wide angle mirror for the same vehicle side are required by law.

Further, systems depicting the vehicle surrounding in bird view are known.

However, especially when driving around corners or when driving forwardly at slow speed, the regions around the vehicle hood are of big importance to be visible or viewable for the driver, for increasing safety in operation of the vehicle for other road users.

### SUMMARY OF THE INVENTION

It is therefore an object of the invention to provide an improved vehicle system for providing indirect view around a commercial vehicle, in particular a long-hood or a short-hood commercial vehicle, wherein the region around the vehicle hood can be better monitored in a clearly arranged and simple manner for the vehicle driver.

The concept underlying the vehicle system for providing indirect view around a commercial vehicle is to provide two different image capture units, which are substantially directed opposite to each other, i.e. such that the first image capture unit, while being provided next to the driver's cabin or the front wheels of the vehicle in longitudinal direction of the vehicle, captures images oriented in a direction which is opposite to the main driving direction of the vehicle, i.e. backwards. This first image capture unit can be formed by a conventional, usually required a main mirror, which is essentially directed backwards, or can be formed by an additional unit, like a camera system, or can be formed by a replacement for the mirror, e.g. a camera system. The main driving direction of the vehicle is the forward driving direction. Further, a second image capture unit is provided, preferably at approximately the same location in the longitudinal direction of the vehicle, and captures images in a direction essentially in vehicle main driving direction, i.e. in direction to the front. This means that the directional component of the optical axis or the angle of view of the image capture units is in and opposite to the main driving direction, i.e. the forward driving direction, of the vehicle.

The term “directional component” denotes a vector component of the Euclidian directional vector when decomposed in Cartesian coordinate components. The Euclidian directional vector is the directional vector of the first and second image capture units, respectively, or their respective optical axis, which is defined as an Euclidian vector starting at the respective image capture units as its initial point. The Cartesian system is e.g. such, but not limited thereto, that the x and z components span the middle plane of the vehicle, wherein the x component is defined as the intersection of the middle plane of the vehicle in longitudinal direction with the ground plane and is positive in forward direction. In this case, the directional component which is in the main driving direction corresponds of the positive x-directional component.

At least the images and image data captured by the second image capture unit is input in a calculating unit. This calculating unit extracts, preferably dependent on a driving situation, data from the image data of the second image capture unit and forwards this data as information to a vehicle assistance device and/or to an autonomous vehicle guidance device. Alternatively, the calculating unit extracts image data from the image data received from the second image capture unit and forwards this to a display device, which is provided within or next to a driver's cabin, such that the driver can view the region captured by the second image capture unit with a glance at the respective display unit. The calculating unit might be provided together or separately from the image capture unit or image capture units, for example by providing a vehicle ECU.

As the second image capture unit is oriented such that it captures a region immediately adjacent to the vehicle hood and possibly at least parts of the driver's cabin on the side of the vehicle hood and a region immediately forward thereof, a region which was previously not visible or viewable by the driver while driving, either by direct view of by indirect view, can now be seen with a glance at the display unit. By image data analysis objects in this region representing a possible danger, for example children or cyclists, can be recognized easily and the vehicle assistance device or the autonomous vehicle guidance device might trigger the respective suitable information outputs to the driver and/or influence the vehicle conditions, for example speed, appropriately.

When displaying the image data on the display device, it is particularly advantageous to display the image data together with image data from the first image capture unit, for example in split screen mode on a common display provided in the driver's cabin. Any picture-in-picture representation can advantageously be used. Alternatively, separate displays might be provided.

In this context, it is particularly useful if the first and the second image capture units are formed by a camera device or an image sensor, respectively. In this case, the optical axis of the camera device or the image sensor is directed in the first and second direction, respectively, i.e. in a direction substantially parallel to the front-rear-direction of the vehicle or at least comprising a directional component extending in the front-rear-direction of the vehicle, respectively, wherein the first image capture unit is directed to the rear of the vehicle, whereas the second image capture unit is directed to the front of the vehicle. In this case, if both first and second image capture units are formed by a camera device or an image sensor, the image data of the second image capture device might be represented as a picture within the picture of the image data of the first image capture device. Further preferably, the first image capture device is adapted such that it captures a field of view including the fields of view of and/or typically provided by a main mirror, a wide angle mirror and a fender mirror or at least two of these mirrors. This allows a particularly comprehensive representation for the driver.

Alternatively, if only the second image capture unit is formed by an image sensor or a camera device, the first image capture unit is preferably formed by a mirror, for example a main mirror or an fender mirror. In this case, the relevant view into the areas to the back of the main/fender mirror is provided by the main/fender mirror, whereas the view to the front, especially the front of a long-hood or a short-hood commercial vehicle, is provided by the second image capture unit formed by a camera device or an image sensor.

The system according to the invention is preferably used in combination with a conventional mirror system comprising at least a main mirror which is directed backwards and captures the region to the side and behind the truck on one side of the truck and extending to the horizon. Preferably, an additional wide angle mirror ensuring sufficient view into a more forward region than the main mirror is additionally provided as a conventional mirror. In this case, the second image capture unit is preferably disposed within the mirror housing.

One or both of these conventional mirrors might also be provided as virtual mirrors, i.e. their images might be captured by image capturing devices separate from the vehicle system for providing indirect view around a commercial vehicle, as described for example in U.S. Pat. No. 8,953,011.

In a preferred embodiment, especially when at least one conventional side mirror is provided, the second image capture unit and/or the first image capture unit are provided within the mirror housing of this mirror. It is particularly advantageous if the second image capture unit is disposed at a distance with respect to a vehicle side surface, because this allows sufficient view onto the most relevant region next to the vehicle's hood. In particular, if doing so, even when using a camera or an image sensor as second image capture unit having a symmetric optical axis, this optical axis might be directed such that it crosses the ground plane next to the vehicle hood, i.e. in exactly the region where the most undistorted view is required.

Alternatively, a separate housing might be provided for the first and/or second image capture unit. This separate housing, which preferably accommodates both the first image capture unit and the second image capture unit, is preferably provided at a top portion on the side of the driver's cabin. Preferably, the angle of view of the second image capture unit is directed such that it crosses the ground plane with its central axis, for example the optical axis of a camera device or image sensor, in a region extending from the side surface of the vehicle where the image capture unit(s) are provided, to the front of the vehicle and beyond and farther to the side of the vehicle, i.e. in a region extending on a side of the vehicle from the position of the second image capture unit to the front of the vehicle and on the respective side of the vehicle.

In any case, it is particularly preferable if the first and the second image capture units are disposed in a common housing or/and intermediately adjacent each other.

Preferably, the horizon is visible by choosing an appropriate angle of view of the first and/or second image capture unit. In a further preferred embodiment, the middle axis of the angle of view of the image capture device crosses the ground plane in a region on the side of the hood of the vehicle, wherein the image capture unit itself is provided in longitudinal direction of the vehicle at a position corresponding to the rear end of the vehicle hood (or the front end of the driver's cabin). The distance where the optical axis or the main axis of the angle of view of the second image capture unit crosses the ground plane in lateral direction is preferably selected such that it crosses within a region which is not accessible by direct view to the front, i.e. a region adjacent to the driver's cabin on the side of the vehicle and adjacent to the hood of a long-hood or short-hood commercial vehicle.

Further, it is preferred that the position and orientation of the second image capture unit and the image data captured by this image capture unit and possibly displayed on a display device within the vehicle is such that it includes a vehicle reference, for example the vehicle wheels, a bumper, entrance steps into the driver's cabin, or a region below the A-pillar (cowl) of the vehicle. By doing so, it is easier for the vehicle driver to interpret pictures captured and displayed on the display device, i.e. to attribute a correct position of possible obstacles appearing in the image displayed on the display device.

A corresponding vehicle reference can be captured by the first image capture unit and/or the second image capture unit. This is particularly useful if a camera device or an image sensor is used and the corresponding image data is displayed such that it can be easily viewed by the vehicle's driver.

Instead of capturing vehicle reference data by at least one of the image capture devices, it is also possible to virtually overlay virtual vehicle reference data. In particular, this can be, for example, an image which is stored in the calculating unit and which is generated from previously taken image data or a fully virtually generated image.

When using an image capture device having an asymmetric optical axis, the entire image sensor area can be used for capturing image data, wherein at the same time the most relevant portion, i.e. the border portion to the hood or driver's cabin, the front bumper, a fender, etc. is captured (and subsequently displayed) substantially undistorted, without the need of image data modification.

The above described system is particularly useful for integration in a conventional mirror system or any other conventional image capture system which is fixed to the vehicle such that is projects a certain distance L, for example 1 to 12 inch, to the side of the vehicle. Additional mirrors, like a fender mirror, can be omitted, because the relevant information can be captured by the vehicle system and provided to the vehicle's driver, such that the wind resistance is lowered and a maximal possible unhindered direct view over the vehicle's hood is possible. The possibility to omit additional mirrors, like for example the fender mirror, additionally allows to positively influence the fuel consumption.

In addition, providing additional sensors to the vehicle system for providing indirect view around a commercial vehicle, especially in the side areas of the driver's cabin and the hood of the commercial vehicle, like for example ultrasound or infrared sensors, allows to further detect and categorize objects within a danger zone around the vehicle, not only by image data analysis but also by secondary sensors. Accordingly, driver assist systems or autonomous vehicle guidance devices might take advantage of such information and correspondingly influence the driver's attention by outputting corresponding warning signals and/or by triggering appropriate vehicle responses, for example lowering the driving velocity, blocking turns etc. especially if using combinations of information gathered from these additional sensors and image analysis data.

If a display device is provided, this might be formed and arranged like a conventional mirror, i.e. to the exterior of the vehicle, on a separate display device within the driver's cabin or, for example, as a projection onto the A-pillar or any other wall limiting the driver's cabin.

As used in this specification, the directions “forward”, “rearward”, “left” and “right” are each based upon the forward driving direction of the commercial vehicle, i.e. “side” means a direction to the left or to the right of the vehicle and substantially perpendicular to the vehicle's longitudinal axis.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, the invention will be described in a purely exemplary manner with the assistance of the appended figures.

FIG. 1 shows a top view of a commercial long-hood vehicle comprising a vehicle system according to the present teachings and illustrating fields of view on the ground around a commercial vehicle.

FIG. 2 is a top view corresponding to FIG. 1, wherein the position of the field of view of a second image capture unit is illustrated.

FIG. 3 is a side view of a commercial vehicle according to FIG. 1 and illustrates the second image capture unit of the vehicle system according to the present teachings.

FIG. 4 is a detailed view of a vehicle system according to the present teachings and illustrates its attachment to the top of the driver's cabin side surface.

### DETAILED DESCRIPTION OF THE PRESENTLY PREFERRED EMBODIMENTS

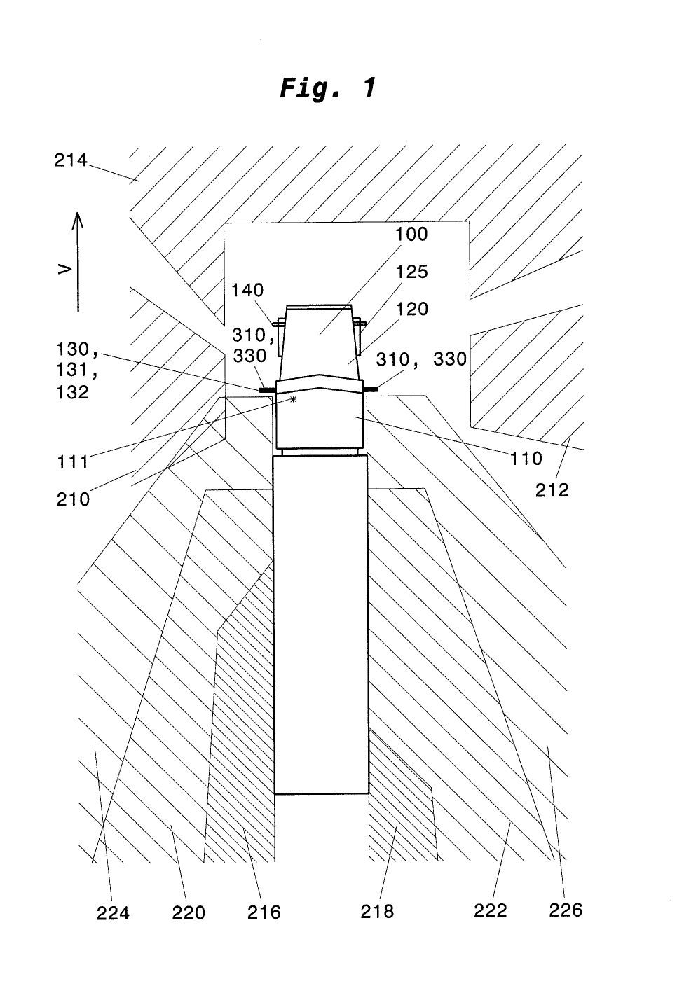

FIG. 1 shows in top view of a commercial vehicle 100. The depicted commercial vehicle 100 is a long-hood vehicle having a driver's cabin 110 and, in the vehicle main driving direction V, in front of the driver's cabin 110 a hood 120. The invention is equally appropriate for short-hood vehicles, wherein the hood 120 has a shorter length in the vehicle's main driving direction V.

The vehicle's main driving direction V is a direction which is substantially parallel to a middle plane of the vehicle extending in longitudinal direction of the commercial vehicle, for example a truck. The main driving direction is thereby the direction when the vehicle 100 drives forward.

While driving, the driver is seated in the driver's cabin 110 and has his eye point 111 at a position denoted by reference number 111. FIG. 1 illustrates the situation for countries having right hand side driving.

The commercial vehicle 100 has at the front end of the driver's cabin 110 side mirrors 130 (or one side (main) mirror 130) extending in the lateral direction, i.e. to the right and to the left of the driver's cabin 110, respectively. The mirrors 130 comprise a main mirror 131 (primary mirror) and possibly a wide angle mirror 132. In addition, the commercial vehicle 100 might comprise fender mirrors 140 provided at the hood 120 and aligning in longitudinal direction with the front wheels 125 of the commercial vehicle 100.

Especially the main mirror 131 and the wide angle mirror 132 might be provided either as conventional mirrors or as, for example, camera display systems, having as a display a device which is positioned at a corresponding location as a conventional main and wide angle mirror, respectively.

A driver when seated in a driver's cabin 110 and having his eyes at the eye point 111 enjoys a direct view through the side windows of the vehicle 100 into the regions shown in FIG. 1 (with hatchings from the top right to the bottom left) hatched and denoted with reference numbers 210, 212, respectively. Further, when looking out of the front window of the vehicle, the driver enjoys a direct view on the front hatched region 214 (hatchings from top right to bottom left). As can be clearly seen from FIG. 1, the region immediately adjacent and bordering to the vehicle, i.e. the region on the ground next to the vehicle 100, cannot be seen by the driver when seated in the driver's cabin 110, because the view is obstructed by non-transparent components of the commercial vehicle 100, like for example the A-pillar or window frames or the vehicle hood 120.

In addition, by making use of the side mirrors 130, especially the main mirror 131, the driver has an indirect view into the regions 216, 218 on the left hand side and the right hand side of the vehicle, respectively. As will be appreciated from FIG. 1, these indirect view regions 216, 218 made accessible by the main mirrors 131 start considerably far behind the driver's position (to the rear of the driver's position) in the longitudinal direction of the vehicle 100 and extend mainly to the rear. By using additionally wide angle mirrors 132 the driver enjoys an indirect view into the ground plane regions 220, 222 which start also considerably behind the driver's cabin 110, but in front of the indirect view regions 216, 218, and also extend to the rear, thereby opening at a wider angle than the indirect view regions 216, 218.

In the present embodiment, the commercial vehicle 100 is also provided with fender mirrors 140, which enable the driver, who is seated in the driver's cabin 110 and has his eye points at position 111, an indirect view into the indirect view regions 224, 226 which, compared to the indirect view regions 220, 222 provided by the wide angle mirror 132, enable a view into regions next to the vehicle on the left hand side and the right hand side at a more forward position and at a wider opening angle.

Regions into which the driver has a direct view are hatched from the top right to the bottom left, regions of indirect view are hatched from the top left to the bottom right.

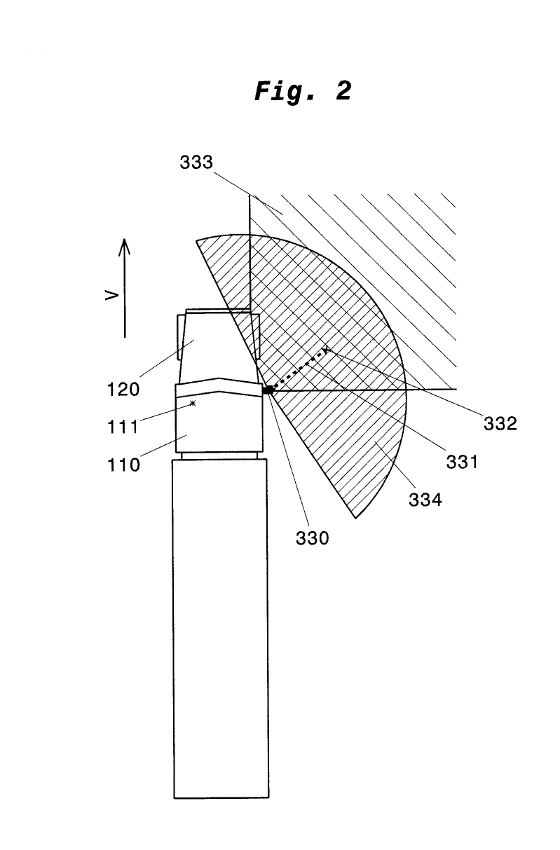

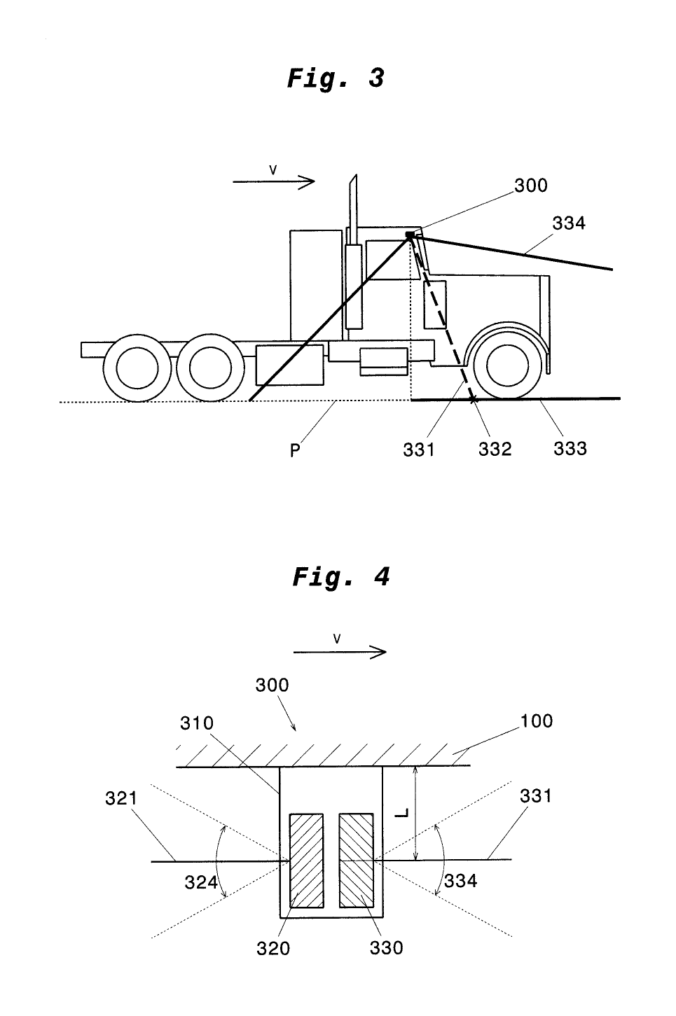

In addition or as a replacement to the fender mirrors 140 and/or the wide angle mirrors 132, the vehicle is provided with a vehicle system 300 for providing indirect view around a commercial vehicle 100, especially in the near region of the vehicle hood 120 and the driver's cabin 110. The vehicle system 300 comprises in the embodiment, which is shown in FIG. 4, a housing 310 in which a first image capture unit 320 and a second image capture unit 330 are integrated. As shown in FIGS. 1, 2, the first and the second image capture units 320, 330 of the vehicle system might be integrated within the housing of the side mirror 130 or, as shown in FIGS. 3 and 4, might be provided as separate units. The first and the second image capture unit 320, 330 are, as can be seen in FIG. 4, provided at a distance L from the side of the vehicle 100, in particular an outer surface of the driver's cabin 110 of the commercial vehicle 100.

In the embodiment depicted in FIGS. 3 and 4, the fender mirror 140 of FIG. 1 is replaced or substituted by the first and/or second image capture unit 320, 330, which is formed, for example, by a camera device or an image sensor. Alternatively, the fender mirror 140 might serve as part of the first image capture unit 320, as it is shown in FIG. 1. As a further alternative, the fender mirror 140 might be kept and additionally the system 300 as depicted in FIG. 4 might be provided.

As can be best seen from FIGS. 2, 3 and 4, the second image capture unit 330, which is formed as a camera device or an image sensor, is directed such that the optical axis 331 of the camera device has a directional component which is directed in parallel to the main driving direction V of the vehicle. Since the second image capture unit 330 is preferably provided at the driver's cabin 110 of the commercial vehicle 100, this means that the sensor axis 131 crosses the ground plane P at a point 332 which is in front of the driver's cabin 110, i.e. in an area 333 denoted with wide hatched lines in FIG. 2. This results in the region immediately adjacent to the driver's cabin 110 and, especially, immediately adjacent to the hood 120 to be captured by the second capture unit 330.

If the optical axis 331 has, as it can be seen in FIGS. 2 and 3, additionally a directional component extending to the side of the vehicle, i.e. in FIG. 2 in the direction rightwards, and is not parallel to the ground plane, the crossing point 332 of the optical axis 331 with the ground plane P can be selected such that it is in the most important region adjacent to the hood 120 and/or the driver's cabin 110 of the vehicle, which is to be seen by the driver by means of indirect view, such that in this region, even without subsequent modification of the captured image, the image capture device 330 can provide a substantially undistorted image.

The optical axis 331, as can be seen in FIGS. 2 and 3, forms the angle sector of the opening angle (view area) 334 for camera devices or image sensors having a symmetric optical axis.

If using an image sensor or a camera device for the second image capture unit 330 having an asymmetric configuration, i.e. an asymmetric optical axis, it is possible to adjust the essentially undistorted captured image region of the second image capture unit 330 such that the captured image is free or nearly free of distortion in a region next to the front wheel 125 of the commercial vehicle 100, the front bumper, or a fender, wherein at the same time the entire sensor area of the image sensor or the camera is used for image capturing.

As can be best seen in FIG. 2, the second image capture unit 330 and its optical axis 331 is arranged such that the opening angle 334 (view area) of the image capture unit 330 allows for capturing a vehicle reference, like for example the front wheel 125 of the vehicle or a front bumper

When displaying an image comprising such a vehicle reference on a display device within the commercial vehicle 100, the orientation for the driver on the image is facilitated.

According to the embodiment shown in FIG. 4, the first image capture unit 320 is also formed by an image capture device like a camera device or an image sensor. This enables to display the images captured by the first and second image capture unit 320, 330 on a common display visible for the driver when seated in the driver's cabin, for example by a picture-in-picture method or by a spilt screen method. The optical axis 321 of the first image capture unit 320 comprises a directional component directed in the opposite direction to the main driving direction V, i.e. backwards. As the second image capture unit 330, the optical axis 321 of the first image capture unit 320 might comprise a directional component in the up and down direction of the vehicle 100 which is such that the image captured by the first image capture unit 320 comprises a horizon view, i.e. that the optical axis 321 of the first image capture unit 320 crosses the ground plane P at a point far behind the vehicle or at infinity. Further, the first image capture unit 320 comprises an opening angle (view area) 324.

The image data from the first image capture unit 320 and the second image capture unit 330, or at least the image data from the second image capture unit 330 is fed, possibly together with inputs from others sensors, like for example a steering sensor, a sensor detecting an indicator signal, a speed sensor etc. into the calculating unit, which might be formed by a vehicle ECU. The vehicle ECU provides information extracted from the received image data and possibly from additional sensors to a vehicle assistance device and/or an autonomous vehicle guidance device, such that warnings to the driver can be output or corresponding vehicle conditions can be triggered when a dangerous situation is detected based on the data input in the ECU. For example, the ECU can detect a possible obstacle, like for example a pedestrian or a bicycle, in a danger zone by analysis of the image data or by inputs from additional sensors, like infrared sensor, ultrasound sensor, etc. Alternatively, or in addition, the vehicle ECU can output data, which can be modified data, to a display device within the driver's cabin or next to the driver's cabin, like for example a virtual mirror, such that the driver can view the area captured by the second image capture unit 330 and possibly the first image capture unit 320. The display of these images is in real time and preferably permanent, i.e. not interrupted by other inputs or other displays.

If the second image capture 330 unit (and possibly the first image capture unit 320) do not capture a vehicle reference, this might be virtually overlaid over the image before displaying it on the display device. For example, a pre-taken image of a vehicle reference, like a bumper or a fender might be used. Alternatively, a virtual image, for example a virtual boundary line of the vehicle, can be superimposed.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A vehicle system for providing indirect view around a commercial vehicle, the system comprising:
a first image capture unit, wherein the first image capture unit is oriented such that an angle of view of the first image capture unit is directed in a first direction comprising a directional component opposite to the main driving direction of the vehicle;
a second image capture unit, wherein the second image capture unit comprises at least one sensor device and is oriented such that the angle of view of the second image capture unit is directed in a second direction comprising a directional component in the main driving direction of the vehicle; and
a calculating unit receiving image data from at least the second image capture unit and providing information extracted from the received image data to a vehicle assistance device and/or an autonomous vehicle guidance device and/or providing image data to a display device within a view of a driver of the vehicle.

2. The system according to claim 1, wherein the second image capture unit comprises at least one of a camera device and an image sensor as the at least one sensor device and the optical axis of the camera device or image sensor is directed in the second direction.

3. The system according to claim 2, wherein the first image capture unit comprises at least one of a camera device and an image sensor, wherein the optical axis of the camera device or image sensor is directed in the first direction.

4. The system according to claim 3, wherein the calculating unit receives image data from the first image capture unit and provides information extracted from the image data of the first and second image capture unit data to the vehicle assistance device and/or the autonomous vehicle guidance device and/or provides image data to the display device.

5. The system according to claim 2, wherein the first image capture unit comprises a mirror.

6. The system according to claim 2, wherein the second direction comprises a directional component in a direction perpendicular to the main driving direction of the vehicle and parallel to the ground plane.

7. The system according to claim 6, wherein the second direction comprises a directional component in a direction perpendicular to the main driving direction of the vehicle and perpendicular to the ground plane.

8. The system according to claim 2, wherein the image data captured by the second image capture device comprises a vehicle reference.

9. The system according to claim 7, wherein the optical axis of the second image capture unit is arranged such that it crosses the ground plane in one of a region next to a front wheel of the vehicle, a region next to a front fender of the vehicle and a region next to a front bumper of the vehicle.

10. The system according to claim 9, wherein the optical axis of the second image capture unit is asymmetric.

11. The system according to claim 2, wherein the second image capture unit is disposed at a distance L with respect to a vehicle side surface.

12. The system according to claim 1, wherein the calculating unit provides image data for display on a display device within the driver's view and is adapted to overlay virtual vehicle reference data on the image data received from the second image capture unit or first and second image capture units for display on the display device.

13. The system according to claim 1, further comprising at least one sensor for detecting the vehicle condition, wherein the calculating unit provides image data for display on a display device within the driver's view and is adapted to switch the display of image data depending on the detected vehicle condition.

14. The system according to claim 1, further comprising at least one additional sensor comprising one of a radar sensor, infrared sensor, and ultrasound sensor, and wherein the calculating unit receives data from the additional sensor and provides information extracted from the image data to the vehicle assistance device and/or the autonomous vehicle guidance device and/or provides image data to the display device depending on the input from the at least one additional sensor.

15. The system according to claim 1, wherein the first image capture unit and the second image capture unit are disposed in a common housing and/or immediately adjacent each other.

16. A vehicle system for providing indirect view around a commercial vehicle, the system comprising:
a first image capture unit with a camera device or an image sensor, wherein the first image capture unit is oriented such that the optical axis of the first image capture unit is directed in a first direction comprising a directional component opposite to the main driving direction;
a second image capture unit, wherein the second image capture unit comprises a camera device or an image sensor as the at least one sensor device and is oriented such that the optical axis of the second image capture unit is directed in a second direction comprising a directional component in the main driving direction; and
a calculating unit receiving image data from at least the second image capture unit and providing information extracted from the image data to a vehicle assistance device and/or an autonomous vehicle guidance device and/or providing image data to a display device within a view of a driver of the vehicle.

17. A vehicle system for providing indirect view around a commercial vehicle, the system comprising:
a first image capture unit formed by a mirror device, wherein the first image capture unit is oriented such that the optical axis of the first image capture unit is directed in a first direction comprising a directional component opposite to the main driving direction;
a second image capture unit, wherein the second image capture unit comprises a camera device or an image sensor as the at least one sensor device and is oriented such that the optical axis of the second image capture unit is directed in a second direction comprising a directional component in the main driving direction; and
a calculating unit receiving image data from at least the second image capture unit and providing information extracted from the image data to a vehicle assistance device and/or an autonomous vehicle guidance device and/or providing image data to a display device within a view of a driver of the vehicle.
